(19) United States
(12) Patent Application Publication
(10) Pub. No.: US 2012/0033825 A1
(43) Pub. Date: Feb. 9, 2012

(54) Captioned Audio and Content Delivery System with Localizer and Sound Enhancement

(76) Inventors: Thomas E. Zinn, II, Alexandria, VA (US); Syddia Lee-Chee, Arlington, VA (US)

(21) Appl. No.: 13/197,344

(22) Filed: Aug. 3, 2011

Related U.S. Application Data
(60) Provisional application No. 61/370,349, filed on Aug. 3, 2010.

(51) Int. Cl. H04B 3/00

(52) U.S. Cl. 381/77

(57) ABSTRACT

A system for transmitting and receiving captioned, pre-recorded and live audio transmissions together with associated text data at a performance venue is provided. The system includes methods for displaying, both visually and audibly, multiple simultaneous captioned audio feeds. Additionally the system provides means for enhancing audio sound quality at a musical venue using a handheld device and a secondary transmission medium. The system provides the ability to select the received transmissions both visually and/or audibly. Additionally, the ability to remotely manage the local transmission system content is provided. A method for providing physical positioning information to users, as well as directional instructions for visually- or hearing-impaired users is also provided. A method for viewing a menu of available audio feeds at a restaurant or sports bar or other venue where multiple TV monitors are available for viewing is also provided.

### STATEMENT OF RELATED CASES

The present application claims the benefit of prior Provisional Application No. 61/370,349, filed Aug. 3, 2010.

### FIELD OF THE INVENTION

The present invention relates generally to methods and means of enhancing the experience of spectator events for persons with particular disabilities, and in a particular though non-limiting embodiment to a system for receiving and transmitting pre-recorded, captioned, and/or live audio transmissions and reducing those transmissions to text data at a venue for the benefit of those whose sight or hearing is impaired.

### BACKGROUND

In 2009 and then again in August of 2010, the Congress of the United States passed and enacted House Bill 3101 and Senate Bill 3404, collectively referred to as the “21st Century Communications & Video Accessibility Act.” These laws specifically mandate that businesses provide access to hearing and sight impaired patrons in public venues.

One of the provisions of the Act requires business owners to provide “accessible user controls for televisions.” Another requires that businesses provide connection to “Internet services” that are built into smart phones.

The aforementioned legislation was passed in recognition of a longstanding problem for those with disabilities. In particular, sight- and hearing-impaired fans and viewers of sporting events, opera, concerts, plays, etc., have always been unable to derive the maximum possible enjoyment from these events due to limitations imposed by their disability. For example, for the visually impaired, even the closest (and most expensive) seating is inadequate to ensure that the viewer is capable of seeing everything intended in the event's production. Likewise, for the hearing-impaired, concerts and plays and other events requiring close attention to the delivery of sounds from the performers are often dissatisfactory, as songs and spoken words intended to convey the meaning of the performance are not adequately delivered to the spectator a manner such that they can be heard and interpreted in a timely fashion.

There is, therefore, a long-standing but as yet unmet need to provide live captioned broadcast feeds to sight-impaired and hearing-impaired People with Disabilities (PWDs) at various locations.

### SUMMARY OF THE INVENTION

A method for simulcasting audio feeds at a location where event data is being displayed or broadcast is provided, the method including: providing a means for receiving a simulcast of the event data that is disposed in communication with a means for managing the simulcast data; and disposing the receiving means in further communication with a personal data device. A system for carrying out the claimed method is also provided, the system including: a receiving means for receiving a simulcast of event data, which is disposed in communication with a means for managing the simulcast data; and a personal data device disposed in communication with the receiving means. A system for providing positioning or localizer information to sight impaired patrons is also provided.

### BRIEF DESCRIPTION OF THE DRAWINGS

FIG. 1 illustrates the claimed system as implemented and used in connection with a sports venue showing associated features.

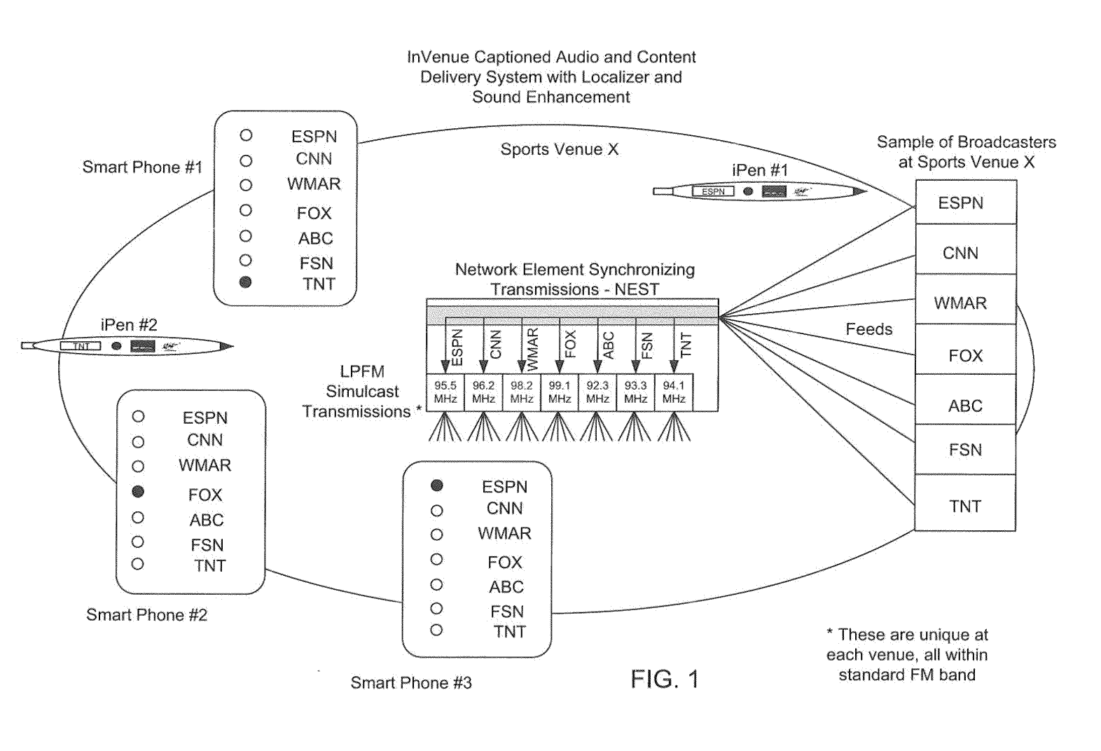

FIG. 2 illustrates example features of the system from the perspective of a prospective user.

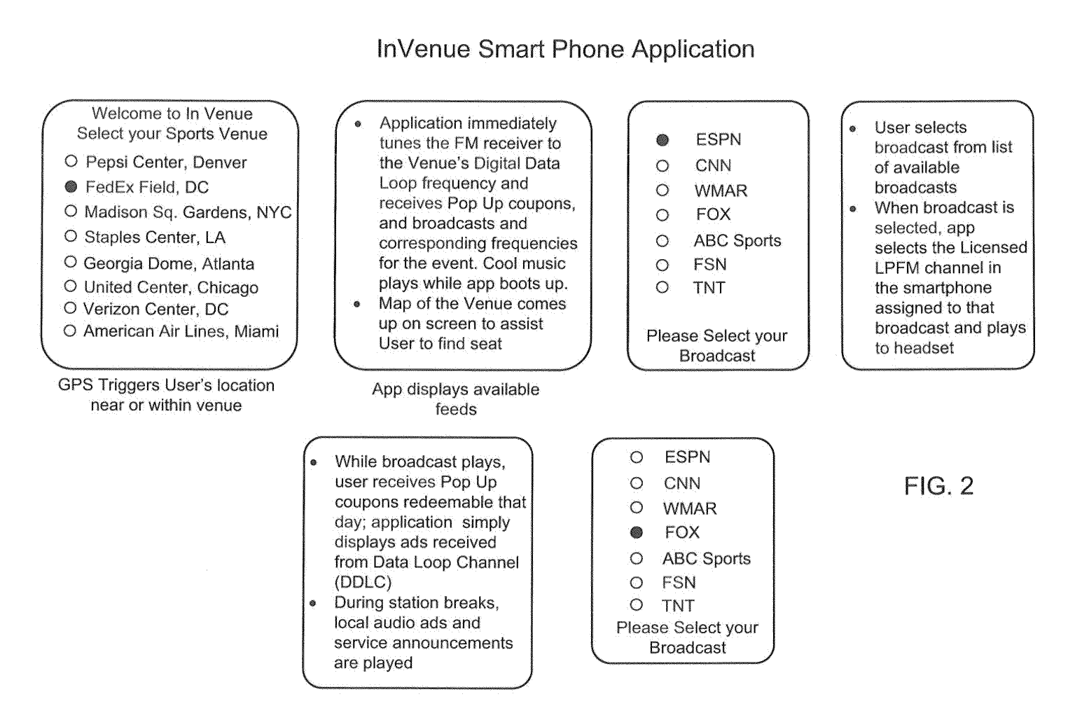

FIG. 3 illustrates the local Network Element Synchronizing Transmissions “NEST”), and some of the basic functionality of an operating system suitable for driving the system.

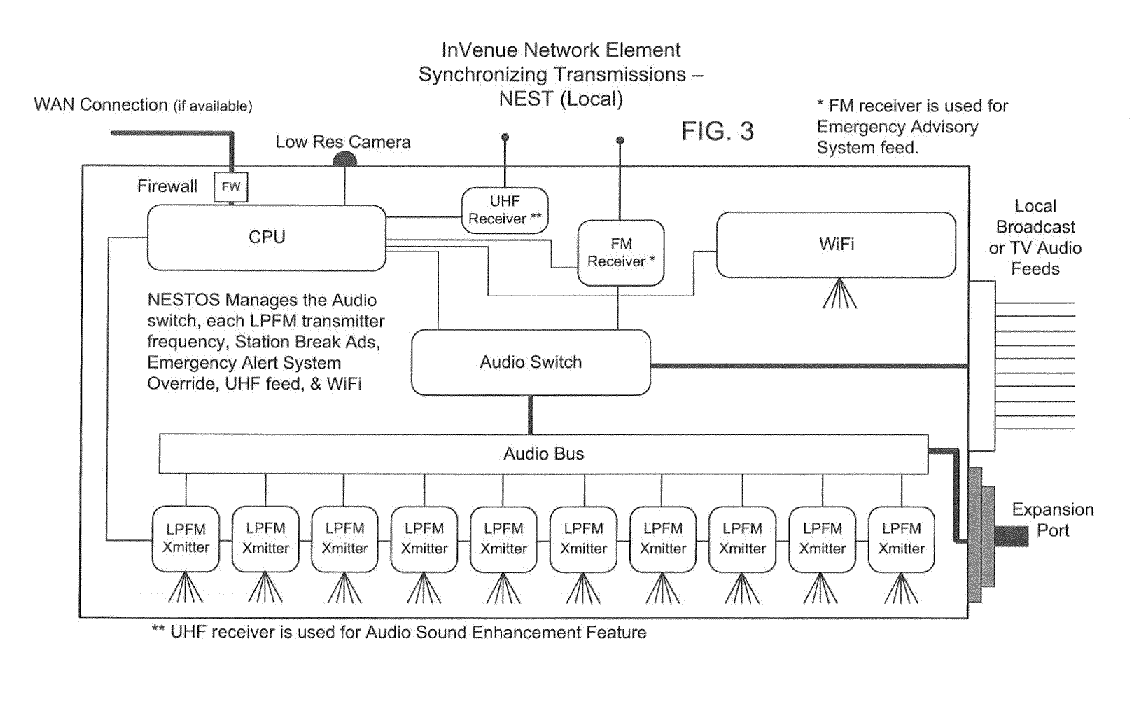

FIG. 4 illustrates a PDA unit being used to receive audio signals by users who don't have access to smart phone technology in a further embodiment of the system.

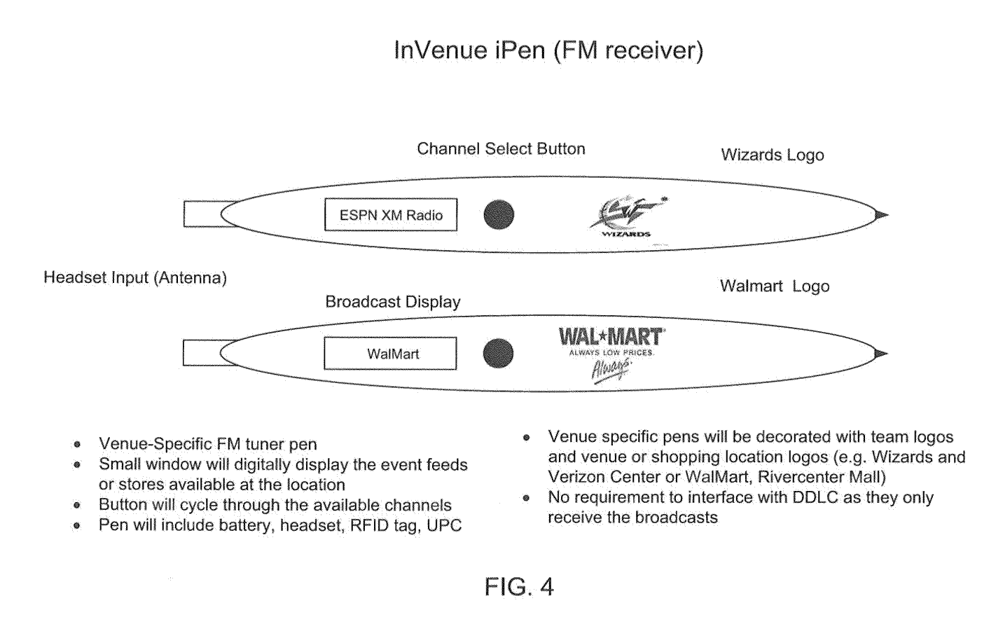

FIG. 5 illustrates the claimed system as deployed in a shopping mall.

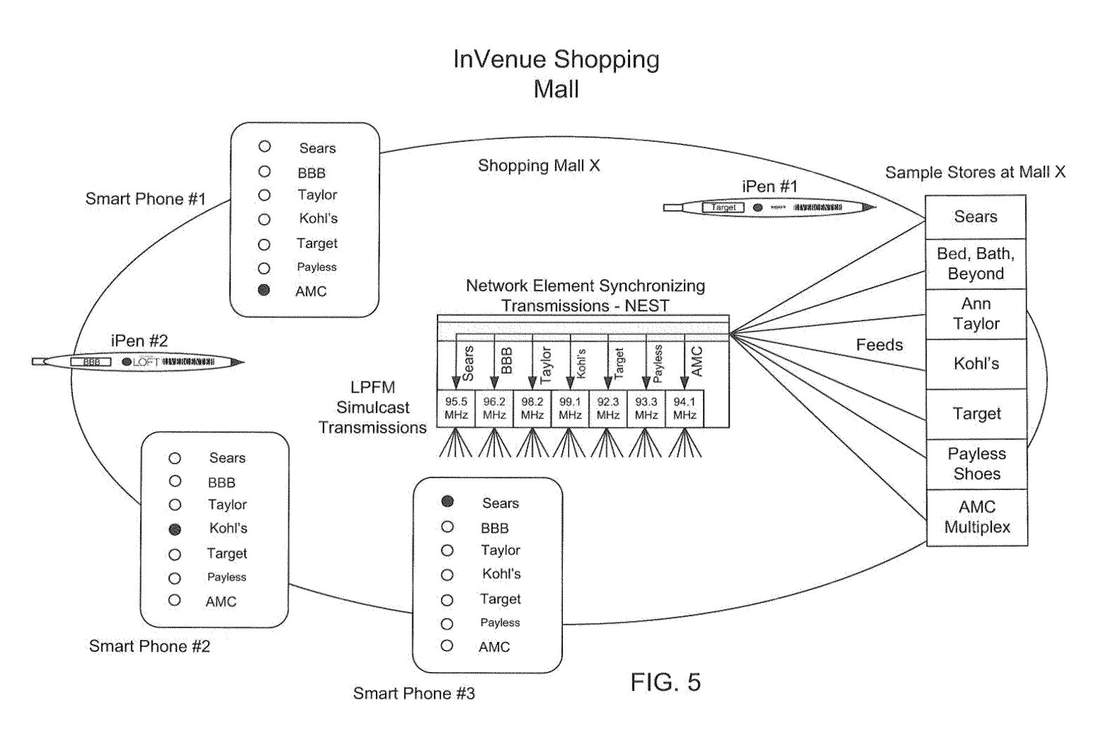

FIG. 6 illustrates the claimed system as deployed in a department store.

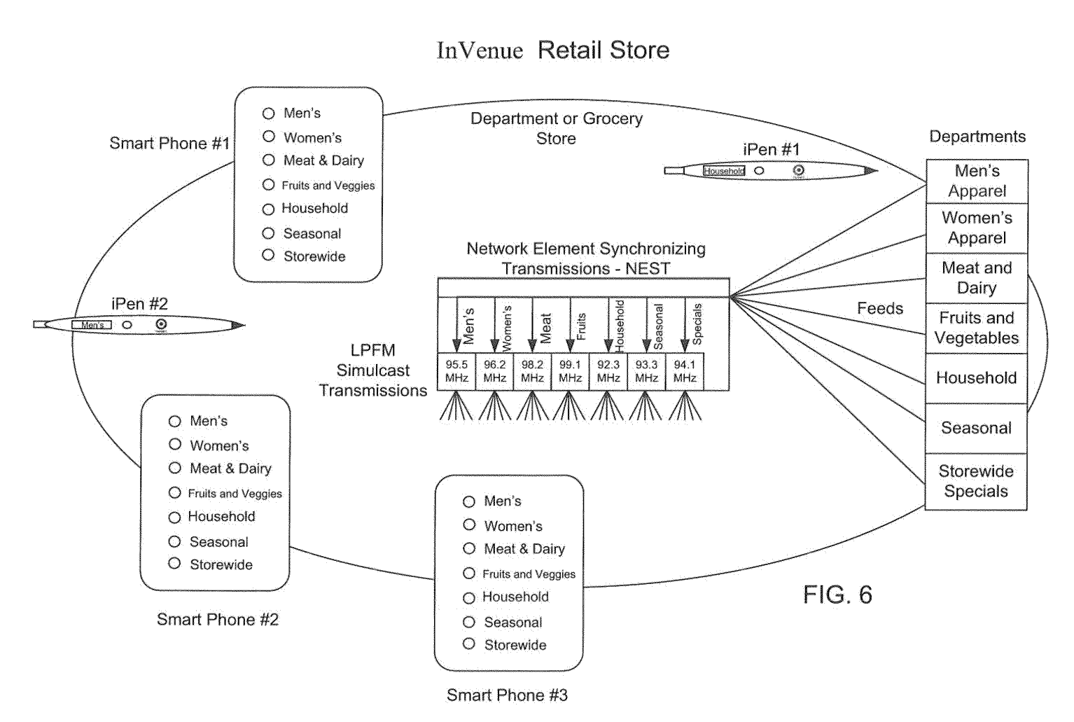

FIG. 7 illustrates the claimed system as deployed in a restaurant or sports bar.

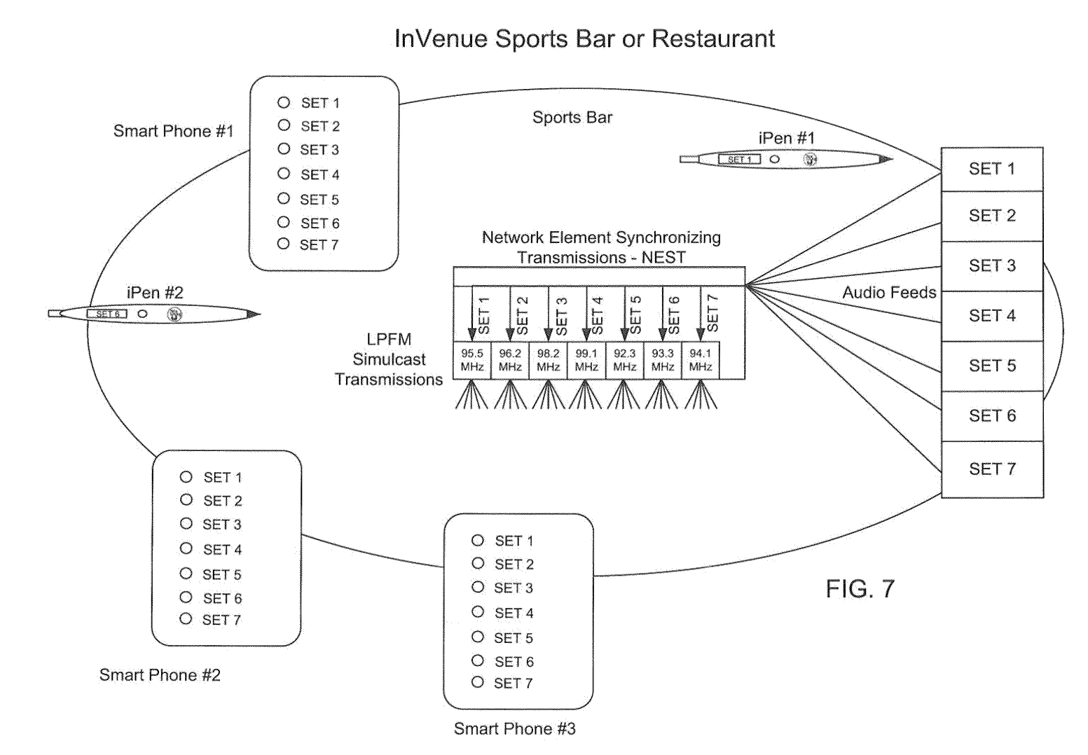

FIG. 8 illustrates the claimed system as deployed in a city, zoo or museum tour.

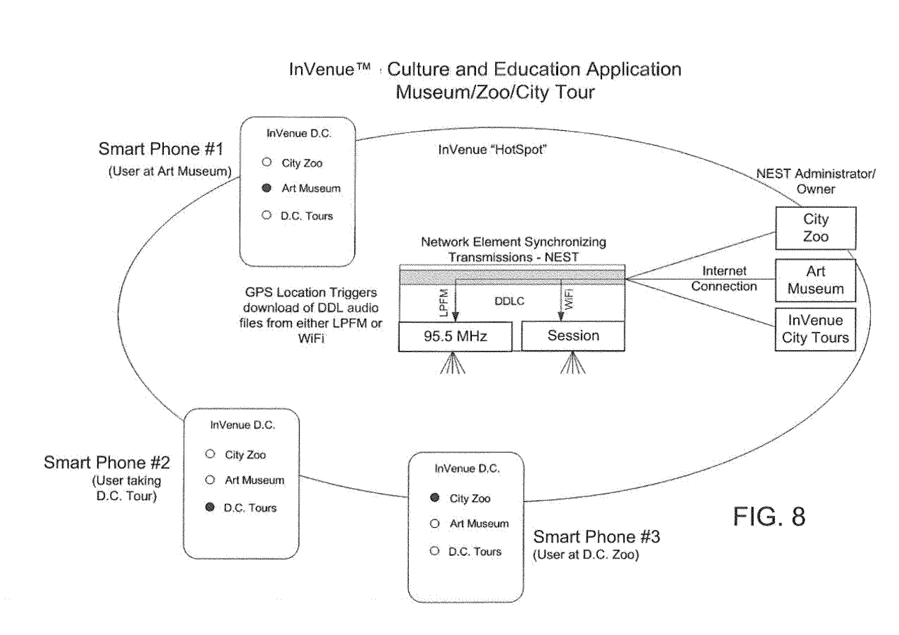

FIG. 9 illustrates the claimed system as deployed in a music hall during a concert exemplifying sound enhancement capability.

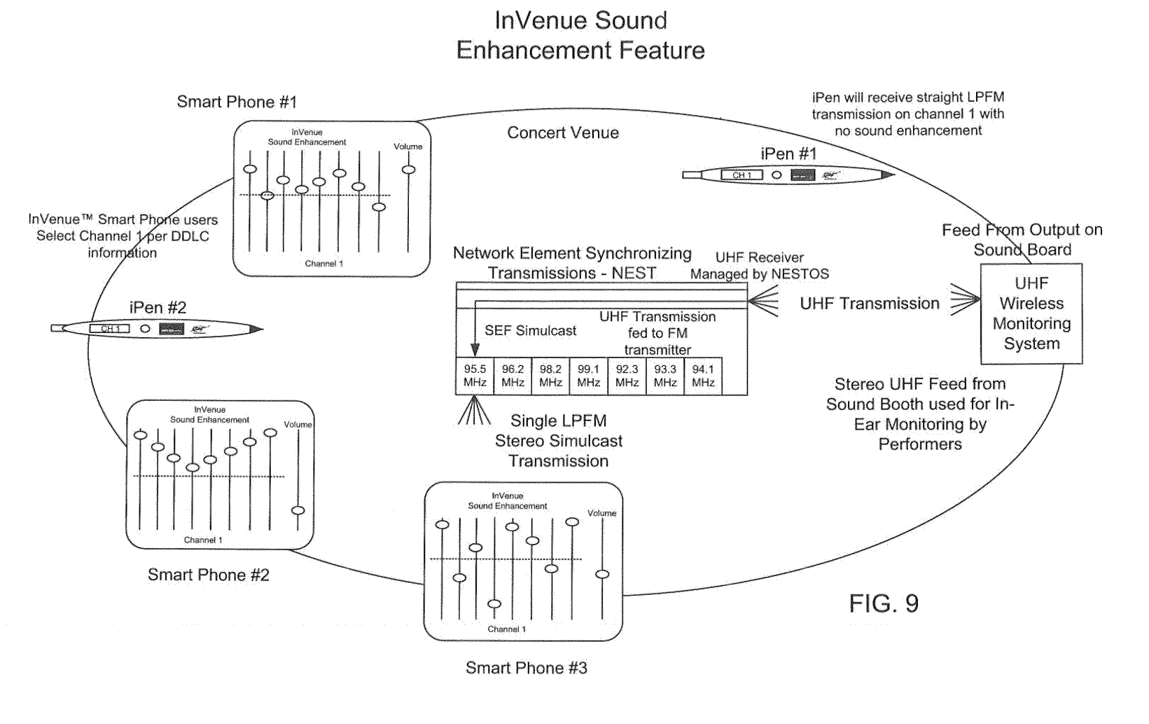

FIG. 10 illustrates the claimed system as disposed in communication with an associated website, including management portal functionality and a database.

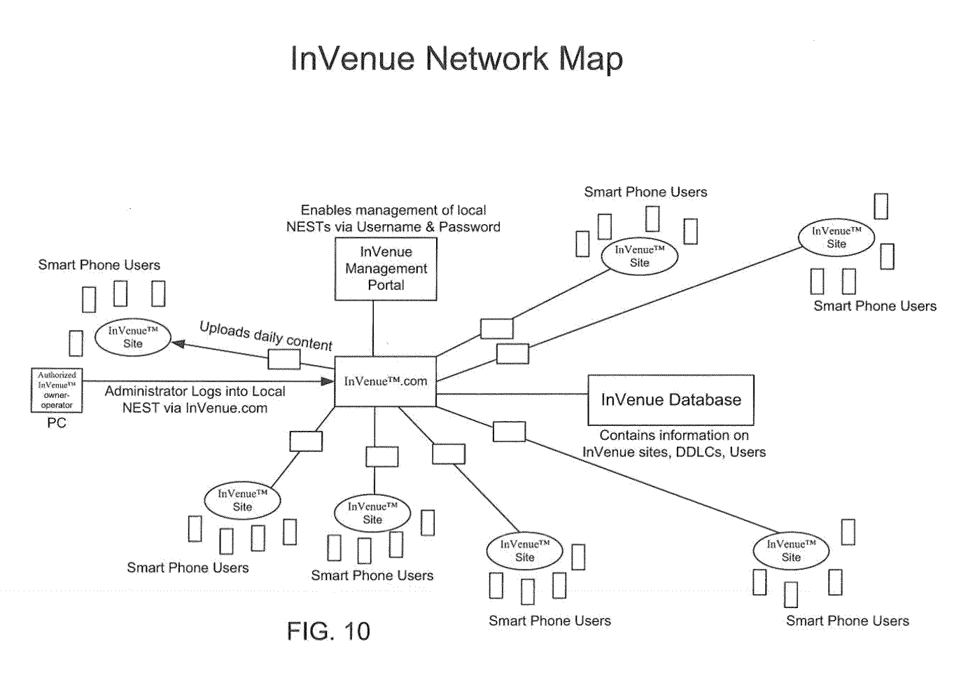

FIG. 11 describes the webpage and database functions shown previously in FIG. 10.

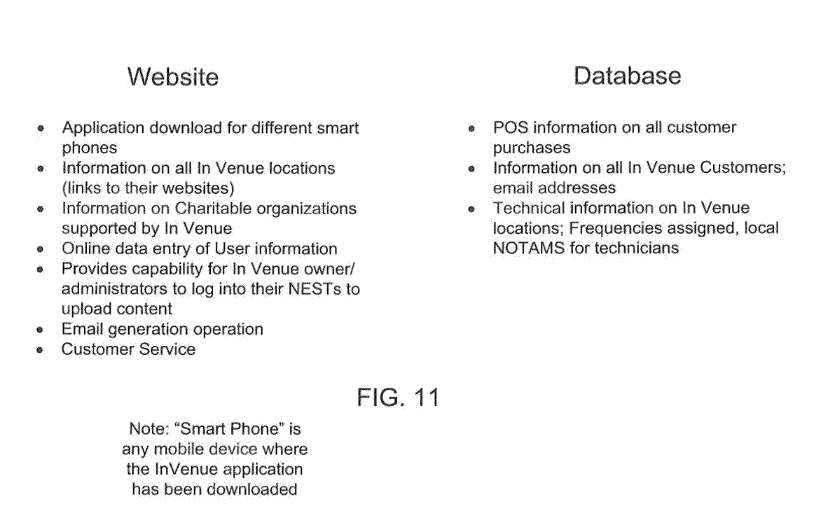

FIG. 12 illustrates exemplary features of a NEST Expansion Unit.

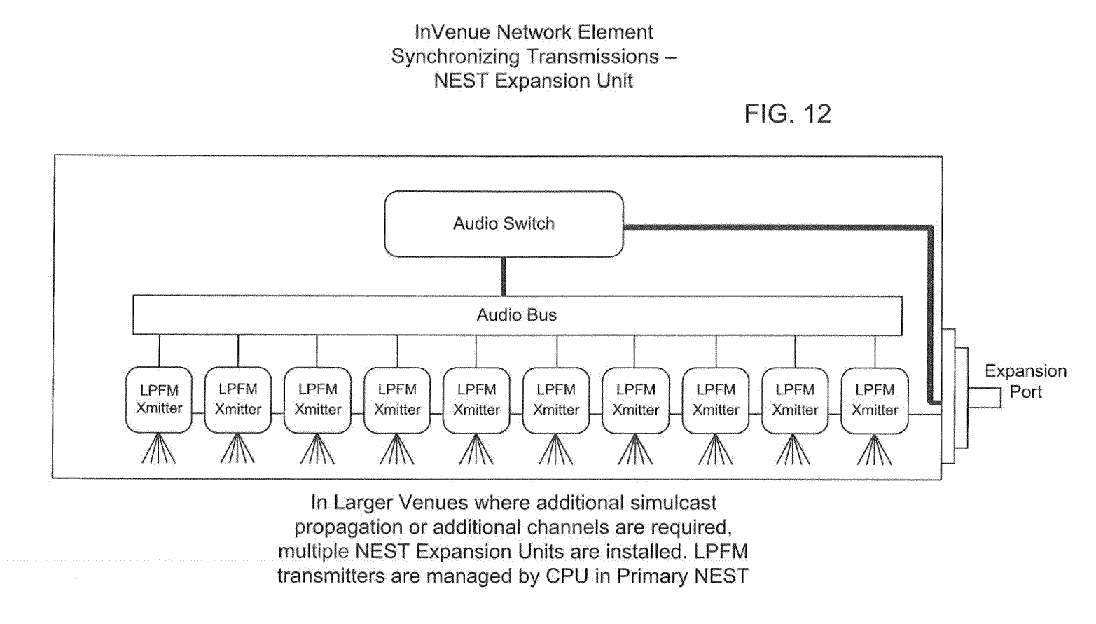

FIG. 13 illustrates exemplary features of NEST Expansion Unit deployed at a representative venue.

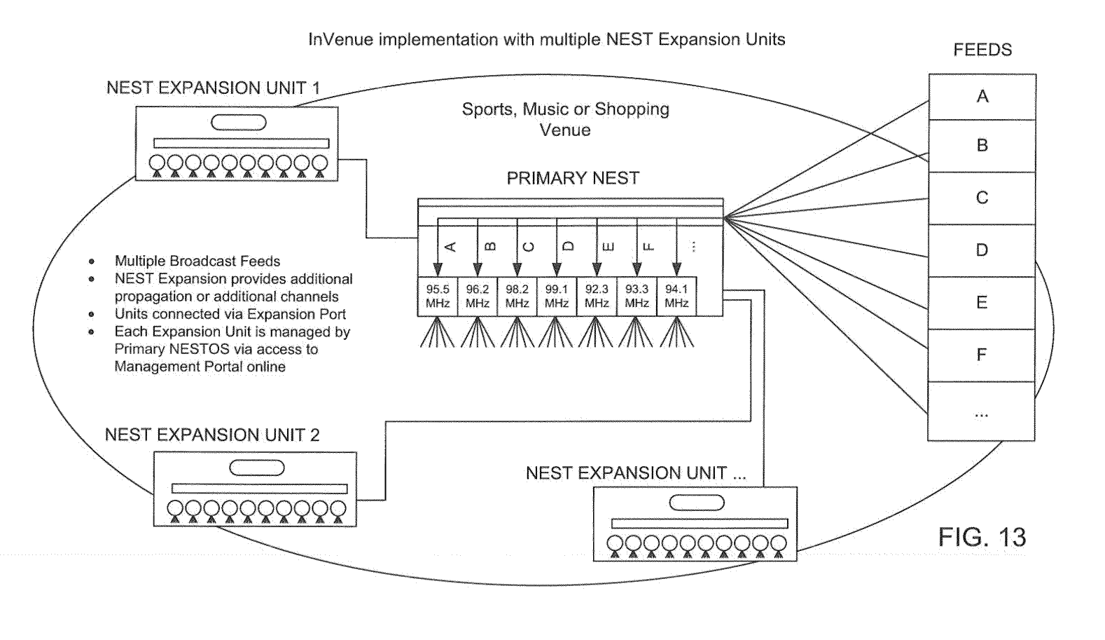

FIG. 14 illustrates example propagation radii for cellular verses FM to support a System to Distribute Disaster Information and Alerts (“SYDDIA”).

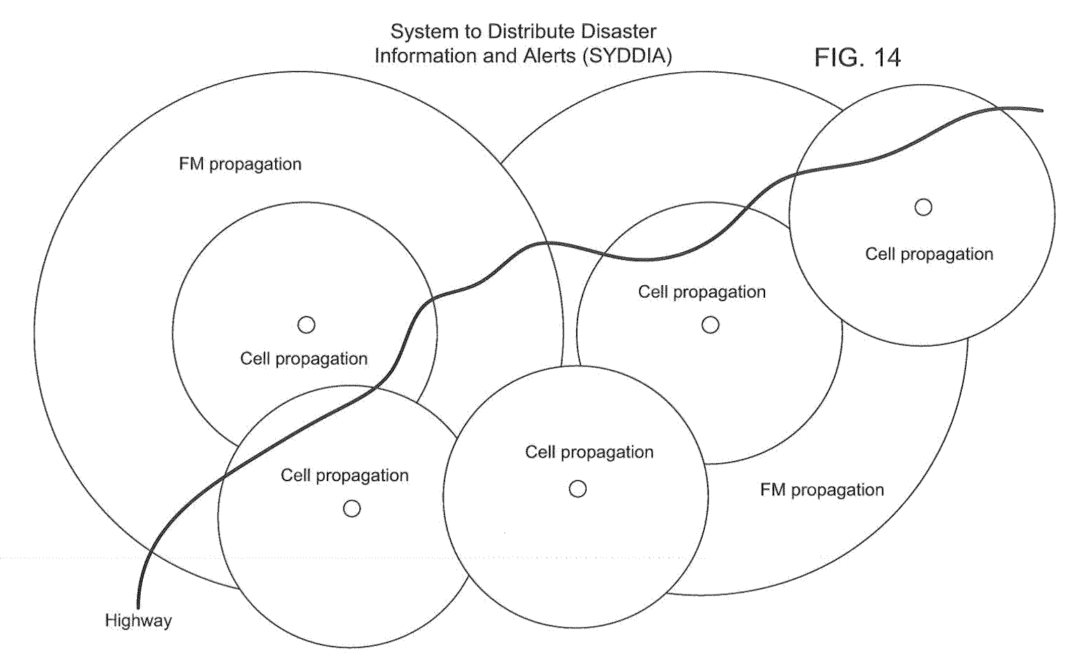

FIG. 15 illustrates an exemplary “SYDDIA NEST”.

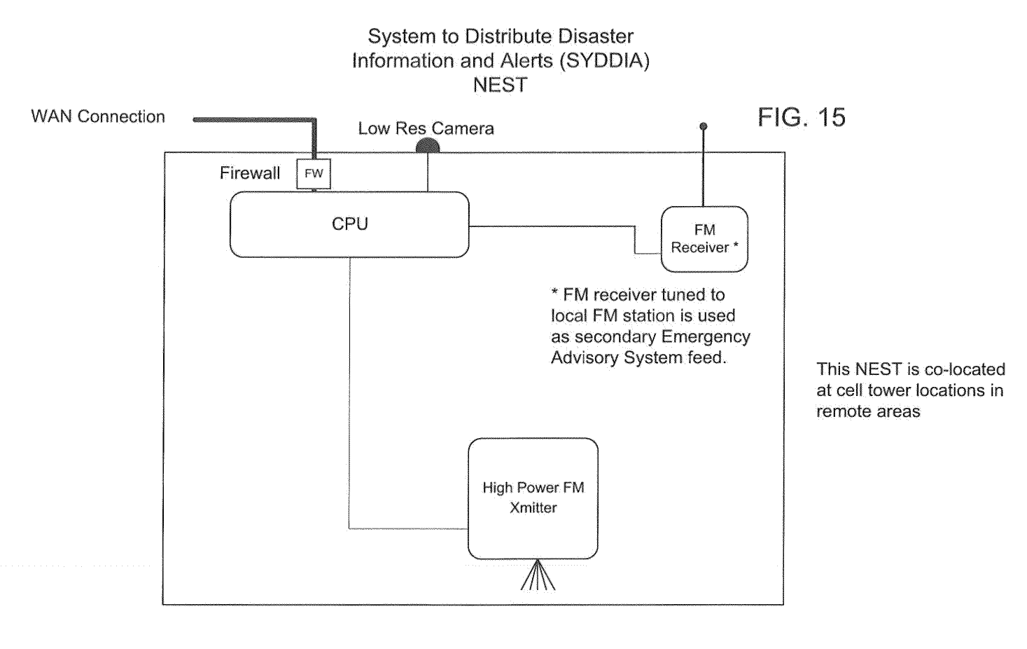

### DETAILED DESCRIPTION OF EXAMPLE EMBODIMENTS

The presently disclosed captioned audio content delivery system can be used to provide cultural and educational information to users at wide variety of venues, including museums, zoos, historical sites/cities, parks, etc., by either manually or automatically downloading geo-tagged audio and text files to a user's smart phone where they are stored until they are geo-triggered or displayed/played at the user's physical location at a particular venue.

In this context, geo-tagging refers to the association of a particular GPS position (e.g., 57 deg 38′ 56.83″ N, 10 deg 24′ 26.79″ E) and a particular audio file. When a unit equipped with a system in which a geo-tagged audio file has been downloaded enters the file's associated position (zone) and the “geo-trigger” feature is activated, the audio file is either played to the user automatically, or cued to manually play when selected.

The system lends access to audio and text services available on the Internet at predetermined locations via a smart phone, and a live, real-time simulcast of video feeds and venue broadcasts. The system helps venue owner and operators incorporate audio enhancement features which simulcast the audio portion of live performances through a smart phone to a user, thereby allowing the user to adjust the volume and enhance audio quality through an equalization function, thereby further enhancing the user's experience.

One advantage of the system's captioned audio transmission model is that the captioned audio feeds are real-time live feeds, which are not carried over Internet connections or via cell signaling which presently creates a lag of between 10 and 25 seconds or so as measured from the actual event, the exact lag time depending on numerous interrelated factors. The system's primary broadcast mechanism is Low Power FM (LPFM) which is simulcast instantaneously to the users of the system. At some locations venue operators provide broadband Internet access (Wi-Fi) for in-house patrons, which not only suffers latency when users tune to online websites dedicated to live streaming but also quickly saturates when multiple users each require a Wi-Fi session. Likewise, when such channels used to stream audio and/or video are provided via cellular connections the local cellular system can also become saturated, depending on the Internet connection or smart phone and the volume of users during the event, which can result in latency, dropped connections and decreased throughput. In contrast, the claimed system doesn't burden the local cell and venue broadband network in order to provide the broadcast feeds, since the audio transactions take place between the smart phone and the co-located Network Element Synchronizing Transmissions (NEST) directly via LPFM and in real time.

Another system feature comprises GPS-enabled localizer information to help people with disabilities to move about the venue in order to locate restrooms, concession stands and exits. As a consequence of the medium being used to transmit feeds to patrons, should an emergency arise requiring that visitors exit the venue, the system captions that information for hearing impaired patrons while it is being transmitted over the loudspeaker. Likewise, should the national Emergency Advisory System be activated, that information will be delivered live and in real time to application users audibly.

Turning now from system functionality to underlying structure, a system comprising a broadcast device running an application, and an associated application operating on a smart phone are disclosed. The application that operates on a smart phone allows a user to access live network audio feeds during a sporting event or any active live or pre-recorded audio feed in any other venue via an FM tuner located in the smart phone when the system broadcast device is present at the venue.

In one embodiment, FM is the primary method of receiving audio and digitized data. These local feeds may also be received from any other FM tuner within range, even those not utilizing the claimed application.

In a further embodiment, the broadcast device receives numerous audio feeds from onsite broadcasters, store owners or restaurant operators' audio feeds from TV monitors, and simulcasts or broadcasts them via licensed a commercial low power FM spectrum (92.1 MHz-107.9 MHz) within the venue or location. These transmissions are performed by a device called a Network Element Synchronizing Transmissions (NEST), which in various embodiments comprise one or more of multiple LPFM transmitters; an Audio Switch and associated Audio Bus; a Central Processing Unit; a NESTOS (NEST Operating System); an FM receiver a UHF receiver; and a Wi-Fi device (router and/or hub), any or all of which may connect to a LAN or WAN circuit, an expansion port and/or a Firewall application. The system also functions without the LAN/WAN connection (i.e., in standalone mode). Those of skill in the art will appreciate that additional features either presently known or later developed may also be added when the LAN/WAN connection is provided. Remote management of the NEST is also provided via the LAN/WAN connection.

Another feature of the system provides disabled persons, and specifically those who are either visually and/or hearing impaired, access to broadcasts, emergency information and/or GPS-enabled location and direction information, all while within a venue.

When used at a sporting event, or from within a broadcast booth, a switch enables an audio feed to connect to a primary NEST installed at the venue in a location central to the audience. In one embodiment, the audio feed is then simulcast via LPFM from the primary NEST and any expansion NESTs installed within the venue. In other embodiments, smart phones running the claimed application or personal data devices located within the venue on pre- or non-pre-configured venue-specific LPFM frequencies then receive any one of a number of associated simulcasts. In still other embodiments, a site administrator, located locally or remotely, may manage and monitor local NEST functionality via a browser-driven interface or management portal. In further embodiments, the management portal allows the site Administrator to upload pre-recorded audio files, or to stream live audio, as well as text messages to the local NEST being managed; in some embodiments, NEST management is accessed through a control means, for example, a Username and Password arrangement.

As a local NEST in the venue receives either the live venue broadcast feed or the pre-recorded or streaming audio feed, the NEST simultaneously transmits the audio feed via one or more of a plurality of LPFM transmitters tuned to predetermined frequencies which may be licensed by the U.S. Federal Communications Commission or another managing agency for use either during a specific event or permanently at that venue.

The local transmission is then received by an FM receiver, which is tuned to that frequency either within the smart phone's FM application (regardless of whether it is managed by the claimed application) or from any other FM receiver located within the local NEST's propagation area within an associated venue. In other embodiments, the NEST is shielded and filtered to propagate a signal within only a particular venue. In larger venues, NEST expansion units may be used to boost the propagation range on the given frequencies used essentially applying distributed antenna system principals but using multiple transmitters on the same channel frequencies.

A smart phone equipped with the claimed application can interface directly with (and in some instances manage) the FM tuner in the smart phone in order to select the desired frequency and play a broadcast being transmitted on that channel.

Generally, the application will not display to the user the frequency being used for the transmission; instead, the user will usually be un-aware of the frequency being used to hear the broadcast, which will simply show up as “channel X, Y, etc.” on the smart phone application screen or other handheld device.

The system in its most basic form does not require either cellular or Wi-Fi coverage within the venue or location to function. However, if these systems are available, additional features and information are available by utilizing the additional bandwidth and functionality provided via the local NEST and smart phone application. If a smart phone does not have FM capability, the NEST may also be simultaneously transmitting on Wi-Fi, but this feature would generally be used as a secondary or backup method of passing data or audio files or streaming audio, as it would require that a standard Wi-Fi session be established between the two devices.

The Smart Phone application is suitable for downloading to a smart phone via an application manager website, and/or through one or more of a plurality of other widely available sites such iTunes™, Blackberry™, or other smart phone application websites. The claimed application provides a user interface on a handset screen from which any application simulcast or broadcast available at any particular application facility may be selected. In other embodiments, the application is variably configurable to receive voice commands, so that sight-impaired users will be able to access and manage the system audibly.

In one embodiment, when the application is selected on the handset, a list of all available venues or locations located near or within a predefined geographical radius of the user where application broadcasts or services are available is displayed. The user then selects related location data, for example, their state and a venue or location where they wish to receive application service as they arrive at the event or location; this selection can optimally be carried out either vocally or by pressing a button on the smart phone. In other embodiments, GPS location capabilities within the phone advise the application host of the specific location the user is located so that this step will not have to be done manually.

GPS positioning technology resident within the smart phone may also be used to identify the user's position within a given venue, thereby triggering selection of a channel providing desired data (Digital Data Loop Channel) in the form of text, coupons, simulcast channels available or pre-recorded audio files. This “geo-triggering” function will enable audio or text files which have previously been downloaded to the smart phone to be played as the user walks through a museum or city where the application tour package has been purchased and downloaded to the phone. In some embodiments, the application tour package is available via a host website, and contains tour packages specific to that city, and may include for example, zoos, museums, historical sites, monument tours, etc.

In other embodiments, once the user has selected the given venue, or the venue has been automatically selected by the GPS features accessed by the application, the application then selects a dedicated Wi-Fi or LPFM Digital Data Loop Channel (DDLC) for that venue.

This channel will typically communicate the availability of one or more of a plurality of channels or frequencies available in the commercial FM band that may be licensed for use at each venue either on a special exception or permanent basis specifically for use by PWDs but available to the general public via the system. These DDLCs will also be available at application hot spots to be determined, and/or transmitted by the NEST at one or more specified venues.

In still further embodiments, once the smart phone application selects a DDLC, user-selected genre music plays over the headset while the device receives the DDLC data stream, which may also contain pop up messages/coupons, audio advertisements, greetings from the owner or manager, audio files specific to a given GPS location and triggered by the unit being in its associated location, and service or emergency information available for the event or given location (mall, museum, etc.) at that time. These may include local (within-venue) and external (outside-the-venue) advertisements from local businesses such as restaurants and sports bars and local stores and other service or emergency announcements.

Such advertisements (pop up text and audio segments) may be sold before the event to local or national establishments. Application service information announcements may be pre-recorded along with other audio and text advertisements and can be played or displayed periodically throughout the event, or triggered while the patron moves about the venue. The audio advertisements and service information may be inserted into the venue-specific broadcast stream when the stations go to a station break, or by NESTOS when the onboard simulcast management system function of NESTOS receives the station break tone.

In further embodiments, once a data loop containing the pop up text and audio advertisements, geo-triggered audio and text files and announcements has run, the smart phone application will then confirm that the loop is complete (e.g., using packets identifying the beginning and end and total bit count of the current DDL included in the loop being transmitted from the local NEST), and will store them for display and playback during an event stored within the smart phone's memory. The pop up advertisements and service announcements may then be displayed throughout the event or visit to the place of business by being played either at time intervals, or via geo-triggering originating from within the application stored in the smart phone. Both audio advertisements and service announcements can be played by the NEST during station breaks; they can also be viewed or heard by the user when selected manually in basically the same manner a user selects a coupon from a newspaper.

In other embodiments, the NEST Operating System (NESTOS) plays event-specific audio advertisements during station breaks on all channels while operating in certain environments, for example, a sports bar or a music venue. Once an audio advertisement has played, it is erased from any associated phones in order to conserve memory. As a convenience, a tone may be played when the broadcast switches to station identification break and again when the broadcast alerts NESTOS of the break.

In various other embodiments, NESTOS monitors all feeds simultaneously, and identifies the station break tone when it is played. When the broadcast begins again, NESTOS may switch each channel back to the live broadcast. This can be manually performed by the broadcast manager by the simple press of a button in the broadcast booth, which signals NESTOS to run advertisements during the station break.

In other embodiments, Wi-Fi or cellular connectivity between the local NESTOS and a smart phone provides an opportunity for broadcasters or local application hosts to send immediate text messages or digital audio files to all registered users present at the venue.

The smart phone may also “check in” with NESTOS via Wi-Fi, and contact can be made between the application user's smart phone and an application server located on the Internet, thereby facilitating instant messaging and other social networking functions.

Once a transmit-receive connection is made between the phone and the Internet, the smart phone application can be updated with new features if a new revision of software has been released, as well simultaneously during the broadcast transmission without interfering with the ongoing broadcast. Wi-Fi and Cellular connections provide a simultaneous and alternate path between the NEST and the smart phone that can be used for any advertisements or audio/text announcements as well.

In other embodiments, when the proper function is enabled, a user's username may be shown in a list that is displayed when the system's corresponding “Who's in the house?” feature is selected. The user's profile may contain whatever information they decide to display about themselves (e.g., username, hometown, phone number, email address, hobbies, etc.). This information is keyed into their profile by the user when the application is initially downloaded into the smart phone.

Optimally, system social networking features interface with other such sites or programs, for example, Facebook™, Twitter™, etc., and selectively display one or more application users present the venue at that time using cellular or Wi-Fi connectivity (if available). The ability to send messages via text or chat to other users in order to coordinate after-event activities is also provided via this feature. Typically, this feature is selected by the user and can be managed by the user via privacy settings.

In other embodiments, at least one channel (either Wi-Fi or LPFM) in each NEST, regardless of its location, is dedicated full time to captioning for the hearing impaired. The actual captioning is typically the resultant function of a third party application; however, the input function is optimally managed by a NESTOS resident within the NEST. Alternative methods for transmitting captioned text include the use of sub-channel capabilities associated with FM systems, thereby admitting to simultaneous stream text captioning via a non-audible sub-carrier, which can be displayed on the screen of a smart phone. Another method comprises captioning over all channels as the application system transmitters broadcast in stereo. The stereo feed can be converted into a uniplex (mono) stream, and the stereo channel used to pass digital captioning from the NEST to a smart phone application where it will be received by the FM tuner and then displayed as text for hearing impaired users. If the user is wearing headphones, only the mono signal (which includes sound and both channels multiplexed) is then heard in both ears, while the captioning is sent to a smart phone application and displayed on the screen as text. A stereo splitter in the NEST may be used to provide this channel separation.

In still other embodiments, an associated sound enhancement system is also provided. As presently configured, the system relies on obtaining a primary feed from the sound system used to transmit live audio from a sound booth mixing board to musicians or actors on stage, which users then receive using their smart phones or in-ear monitors.

Known systems use a UHF channel that is transmitted to the musicians while they are playing. Accordingly, the present system's NEST is equipped with a UHF receiver that can also receive the primary sound channel issued from the UHF system, and then simulcast it via LPFM through one of the application channels within the venue. The application smart phone is then used to receive the primary sound channel via the FM tuner within the phone.

This feature also includes a parametric equalizer function within the smart phone which will allow the application user to modify the sound they hear in their headset or ear buds. Users are able to raise or lower the high-, mid-, and low-range frequencies and volume, thereby mixing received sounds to their personal preferences, live and in real-time. The enhancement system also provides a plurality of different equalization bands to a system user as part of the smart phone application during a concert event, for example, when on-stage, wireless monitoring is being used by the group performing. The UHF tuner in the NEST may be manually tunable to the channel for in-ear monitoring via a system administrator. The NEST may also be capable of scanning UHF channels typically used for in-ear monitoring systems and identifying which frequency is being used for the transmission, and then tuning to that frequency automatically.

A system compatible personal data device is also provided. Such devices are generally known, though all such current products lack the advantages and structure of the application shown and claimed herein. For example, a system compatible personal data device may comprise a venue or location-specific pen, or pen-size device with an FM receiver built into it. A headset plugs into the pen and serves as the antenna much like a smart phone. The application device may have site-specific frequencies being used to simulcast the broadcasts or in-store/mall-related specials selectively pre-set into them, and can be sold to any customer who wants to listen to the application simulcast; or someone with a smart phone without the system application loaded; or anyone else who wants to be part of the application event or experience.

The devices may be sold either locally or online, or instead handed out by venue application operators who want to make audible advertising information available to as many clients as possible. A possible motivation for such cooperation is that operators handing out the devices in exchange for a data card then have access to user email information filled out on a card that comes with the device.

In other embodiments, when an application user visits a system-compatible zoo, museum, or historical site or the like, they are able to download various audio/text packages for that given city either online or by visiting an application “hotspot” normally located at a site in the city where they wish to take the tour. As they approach the museum, a geo-triggering feature establishes a session with the NEST's Wi-Fi to facilitate reception of data via the DDLC, and the DDL is then downloaded with various packages available for purchase by the user. These packages may also be downloaded to the smart phone via wireless connection to the Internet and the system website from anywhere that there is a wireless connection.

Once the DDL is complete, the user simply chooses which package they wish to purchase, whether in a group of museums or historical tours, or individually, where they can select single, limited or customized packages for purchase. Once they select sites they wish to visit, packages are purchased via credit card or other external source such as PayPal™, and un-selected packages are deleted to conserve memory within the phone. In further embodiments, once the user has purchased the package they have a specific amount of time to visit the site and use the package.

In a presently preferred embodiment, the system utilizes geo-triggering of pre-recorded geo-tagged audio files downloaded to a smart phone running the subject application. As the user approaches an application-compatible location, audio files for that venue are cued, and then timely played back as the user walks from system zone to zone in a zoo, or from picture to picture in an art museum, or monument to monument in a city tour, etc. A manual feature can be selected as well, which allows the user to manually select the specific files they want to hear. While playing files, a “pause” function allows the user to pause and/or resume the playback.

At shopping stores or malls, the application can be deployed to promote in-store sales to patrons, similar to the paper advertisements that are currently available when entering stores. In this embodiment, the user can select a particular store once they arrive, or a GPS feature within the phone can automatically enable the application once they have arrived. Once selected, a venue-specific DDLC used to provide sales and special needs audio and pop-up text information is selected by the application. While the DDL is downloading digital audio, text ads and/or public service announcements to be lined up and played, genre music or on-board MP3 music can be played in the background by the application.

According to other aspects, users can at the point of sale show their smart phone or data device, allow it to be scanned, and thereafter receive an application discount for using the system. This advantage naturally enhances the shopping experience of persons with special needs (and other patrons generally) by providing timely, relevant information while they are actually in the store or mall; the user then saves money and is more informed of their purchasing options when using the system. This approach should also increase store sales, as owners and operators will be able to promote their sales specials directly and efficiently through the smart phone or data device to their application patrons as they shop.

In restaurants, gyms or sports bars where numerous television screens are playing simultaneously, the audio portion of each telecast is not usually available to patrons, as this would produce conflicting noise and a generally unpleasant listening environment. The application can therefore be used to provide an audio feed for each of the screens to the user's smart phone or data device for that location. For convenience, screens may also be labeled with a number and assigned to a dedicated channel in the local NEST. When the user enters the establishment, the application selects the DDLC for that location and the corresponding DDL is downloaded together with the screen LPFM channel assignments for that venue.

The smart phone application also provides local merchants both inside and outside the venue an opportunity to send time-sensitive, scheduled or geo-triggered “pop-up” text and audio coupons to application users while they are at the event or shopping venue. Application patrons can redeem coupons which may provide them a discount for being a system user. The phone can receive the coupons via the DDLC (via either LPFM, or by Bluetooth/cell/Wi-Fi, etc.) when the application is initially selected. Emergency information texts, Megan Alerts, Emergency Alert System information and audio segments can also be downloaded to an associated phone via the DDLC or be transmitted to the user end device via one of the active system channels.

In the event of a local or national emergency (e.g., an evacuation, terrorist attack, lost child alert, severe weather, or other similar event) the claimed system can be used to immediately transmit emergency information over all of the local and global NEST LPFM channels simultaneously.

In one embodiment, this feature activates on all local NESTs nationally when either a local or national Emergency Alert System (EAS) has been activated by the application host or by the relevant authorities. An Emergency Alert System Override (EASO) is broadcast by local system NESTs and managed by an associated NESTOS using the system management portal. Manual override access of this function is strictly controlled using the management portal security settings. The security feature provides the capability to transmit voice or text data directly to any system-enabled device by overriding the current application channel broadcast(s) in order to instead disseminate the necessary disaster or emergency information. In other embodiments, an interface is also provided in the NEST to simulcast local public address system messages over all NEST-managed channels when the public address system in the given venue is used. In this manner, no audible messages are missed by the system user.

The security system provides the capability for all system users to immediately have access to emergency information being transmitted via local FM radio stations or via a redundant system of FM transmitters called collectively the SYstem for Distributing Disaster Information and Alerts (or “SYDDIA”). Using the GPS location feature of the mobile device or smart phone, the system phone application “knows” when it is not in a local system location, and may passively monitor a local FM station during that time.

Often, when travelling, mobile device users find themselves in “no service” areas where there is no cell service. It is at this time when they are most vulnerable should an emergency happen. Since the system's primary media of audio transfer is currently the FM capabilities of a smart phone, the security feature provides a direct connection to potentially lifesaving information whenever the EAS is activated.

In the case of a terrorist event, the SYDDIA can be used to pass emergency information to users wherever local FM is available. Even with the system running in passive mode, the system can alert the user that they are in a no-service area, and advise that should they want to receive Emergency Information on their smart phone they need only plug in their headsets to enable efficient reception of local FM signaling. The host system managing the scan feature of the smart phone then passively will lock on to the strongest local FM station and listen for the EAS tone and subsequent Emergency Alert System information. Once the application hears the EAS tone, a message is sent to the system user indicating that they are able to listen to emergency information being provided by the security system.

In an expanded high power application of the standard Emergency Alert system, cellular towers can be used to set up Emergency Use Only FM transmitters that provide a redundant emergency communication system, which would in turn make available EAS information or other managed content directly available to a system user even in remote locations or where cellular coverage is otherwise limited or nonexistent.

Frequency modulated signals propagate much further than standard cellular signals, and offer a stable and time-tested form of analog audio transmission. Using a system of FM transmitters cooperatively located at all towers in a network and then set to transmit EAS or other information of an urgent nature on a locally unique commercial FM frequency in case of an emergency provides the ability for system users to remain in range of necessary local and national emergency information. In one representative embodiment, a high power FM transmitter at a cell tower supporting the security system would be managed by a NEST running a fast, efficient version of the core NEST Operating System, for example, a lighter, simpler version of the standard NESTOS that would manage a single transmitter instead of many.

The foregoing description is intended primarily for illustrative purposes, and is not intended to include all possible aspects of the present invention. Moreover, while the invention has been shown and described with respect to numerous exemplary embodiments, those of skill in the pertinent arts will readily appreciate that various other modifications, omissions and additions may be made without departing from either the spirit or scope thereof.

1. A method for simulcasting audio feeds at a location where event data is displayed or broadcast, said method comprising:
providing a simulcasting system with means for receiving a simulcast of said event data in communication with a means for managing said simulcast; and
disposing said means for receiving in communication with a personal data device.

2. The method of claim 1, said simulcasting further comprising the display or broadcasting of one or more of data, metadata, digitized audio data, textual information and digitized visual data.

3. The method of claim 1, said method further comprising receiving a simulcast transmission from a primary communication source using a personal data device; and using said managing means to enhance audio data received by said personal data device.

4. The method of claim 1, said method further comprising utilizing GPS data to switch a receiver to a predetermined data channel associated with a venue.

5. The method of claim 1, said method further comprising equipping said system with a GPS locator feature; and cueing received data files for playback by users either automatically or manually regardless of whether the GPS locator feature is also selected.

6. The method of claim 1, wherein said method further comprises receiving a simulcast transmission using a personal receiving device equipped with a frequency modulated receiver.

7. The method of claim 1, said method further comprising equipping said system with one or more of a data processor; an audio switch; a UHF receiver; an FM receiver; multiple low power frequency modulation transmitters; an audio bus; a Wi-Fi module; a Firewall; a camera; a cooling fan; and a power supply.

8. The method of claim 7, said method further comprising equipping said system with means to connect a subordinate system to the primary system.

9. The method of claim 7, said method further comprising equipping said means for managing with a computer program for controlling one or more of an audio feed; an audio switch; a plurality of data transmitters; a UHF transmitter; a Firewall; a Wi-Fi unit; a camera; a system management and monitoring tool; and an emergency override system.

10. The method of claim 1, wherein said method further comprises transmitting emergency information to preselected users in response to one or more detected safety conditions.

11. A system for simulcasting audio feeds at a location where event data is displayed or broadcast, said system comprising:
means for receiving a simulcast of said event data disposed in communication with a means for managing said simulcast; wherein said means for receiving is disposed in further communication with a personal data device.

12. The system of claim 1, wherein said system further comprises means for displaying or broadcasting one or more of data, metadata, digitized audio data, textual information and digitized visual data to an associated user.

13. The system of claim 1, said system further comprising means for receiving a simulcast transmission from a primary communication source using a personal data device; and means for using said managing means to enhance audio data received by said personal data device.

14. The system of claim 1, said system further comprising means for utilizing GPS data to switch a receiver to a predetermined data channel associated with a venue.

15. The system of claim 1, said system further comprising a GPS locator feature.

16. The system of claim 1, wherein said system further comprises means for receiving a simulcast transmission using a personal receiving device equipped with a frequency modulated receiver.

17. The system of claim 1, said system further comprising means for equipping said system with one or more of a data processor; an audio switch; a UHF receiver; an FM receiver; multiple low power frequency modulation transmitters; an audio bus; a Wi-Fi module; a Firewall; a camera; a cooling fan; and a power supply.

18. The system of claim 17, said system further comprising means for equipping said system with means to connect a subordinate system to the primary system.

19. The system of claim 17, said system further comprising means for equipping said means for managing with a computer program for controlling one or more of an audio feed; an audio switch; a plurality of data transmitters; a UHF transmitter; a Firewall; a Wi-Fi unit; a camera; a system management and monitoring tool; and an emergency override system.

20. The system of claim 1, wherein said system further comprises transmitting emergency information to preselected users in response to one or more detected safety conditions.
